(19) United States
(12) Patent Application Publication
(10) Pub. No.: US 2020/0082241 A1
(43) Pub. Date: Mar. 12, 2020

(54) COGNITIVE STORAGE DEVICE

(71) Applicant: NorLiTech LLC, Petaluma, CA (US)

(72) Inventors: Guy Paillet, Petaluma, CA (US); Anne Menendez, Petaluma, CA (US)

(73) Assignee: NorLiTech LLC, Petaluma, CA (US)

(21) Appl. No.: 16/373,402

(22) Filed: Apr. 2, 2019

Related U.S. Application Data
(60) Provisional application No. 62/729,676, filed on Sep. 11, 2018.

(51) Int. Cl. G06N 3/02; G06F 3/06; G06N 5/02; G06F 12/0802

(52) U.S. Cl. CPC G06N 3/02; G06F 3/0604; G06F 12/0802; G06F 3/0679; G06N 5/02; G06F 3/0661

(57) ABSTRACT

Embodiments described herein provide a system comprising a non-volatile storage memory, a controller, and a cognitive memory. The storage memory can store data. During operation, the controller programs a function for the system based on a configuration file. The function indicates one or more operations for the data stored in the storage memory. The cognitive memory can include a set of neuron memory cells, which can store a knowledge base for facilitating the function and execute a pattern matching operation between the data stored in the storage memory and the data stored in the set of neuron memory cells. The controller can then execute the one or more operations within the system based on an output of the pattern matching operation from the cognitive memory.

### RELATED APPLICATION

This application claims the benefit of U.S. Provisional Application No. 62/729,676, Attorney Docket No. NLT18-1001PSP, titled “Cognitive Storage Device,” by inventors Guy Paillet and Anne Menendez, filed 11 Sep. 2018, the disclosure of which is incorporated herein by reference in its entirety.

### BACKGROUND

### Field

This disclosure is generally related to the field of storage management. More specifically, this disclosure is related to a system and method for facilitating a cognitive storage device (CSD) that can execute data operations within the CSD.

### Related Art

A variety of applications running on physical and virtual devices have brought with them an increasing demand for computing resources. As a result, equipment vendors race to build larger and faster computing equipment (e.g., processors, storage, memory devices, etc.) with versatile capabilities. However, the capability of a piece of computing equipment cannot grow infinitely. It is limited by physical space, power consumption, and design complexity, to name a few factors. Furthermore, computing devices with higher capability are usually more complex and expensive. More importantly, because an overly large and complex system often does not provide economy of scale, simply increasing the size and capability of a computing device to accommodate higher computing demand may prove economically unviable.

As the demand for computing increases, so too does the demand for high-capacity storage devices. Such a storage device typically needs a storage technology that can provide large storage capacity as well as efficient storage/retrieval of data. One such storage technology can be based on Not AND (NAND) flash memory devices (or flash devices), such as solid-state devices (SSDs). An SSD can provide high capacity storage at low cost. As a result, SSDs have become the primary competitor of traditional hard disk drives (HDDs) as a persistent storage solution. To increase the capacity of an SSD, a number of bits are represented by a single memory cell in the SSD. For example, a single memory cell can store 4 bits in a quad-level cell (QLC).

An SSD can facilitate persistent storage by retaining data without power. Data access on a traditional SSD is performed sequentially, by examining respective pieces of data one at a time. Therefore, a search on an SSD can incur significant latency if the volume of data stored in the SSD is large. In addition, the control functionalities of an SSD can be distributed among the processors of a host device and the flash controller of the SSD. However, this can lead to an increased bottleneck for the SSD and may limit scaling. Furthermore, since a storage node in a datacenter can deploy multiple SSDs, the storage of data in the SSDs can lead to large power consumption and may require extensive methods of cooling.

Even though SSDs have brought many desirable features to efficient and high-capacity data storage, many problems remain unsolved in analysis of the stored data.

### SUMMARY

Embodiments described herein provide a system comprising a non-volatile storage memory, a controller, and a cognitive memory. The storage memory can store data. During operation, the controller programs a function for the system based on a configuration file. The function indicates one or more operations for the data stored in the storage memory. The cognitive memory can include a set of neuron memory cells, which can store a knowledge base for facilitating the function and execute a pattern matching operation between the data stored in the storage memory and the data stored in the set of neuron memory cells. The controller can then execute the one or more operations within the system based on an output of the pattern matching operation from the cognitive memory.

In a variation on this embodiment, a neuron memory cell in the set of neuron memory cells can include a recall memory and triggering circuitry. The recall memory can store a reference pattern indicated in the knowledge base. The triggering circuitry determines a distance between an incoming pattern indicated in the pattern matching operation and the reference pattern.

In a further variation, a respective committed neuron memory cell in the set of neuron memory cells receives the incoming pattern in parallel. The triggering circuitry can then trigger the neuron memory cell if the distance is the smallest distance among a set of distances, which are associated with the incoming pattern and calculated by the set of neuron memory cells.

In a variation on this embodiment, the controller can select the configuration file based on a requirement of an application and obtain the configuration file from the storage memory.

In a variation on this embodiment, the controller can obtain the knowledge base from a set of knowledge files stored in the storage memory and load them to the set of neuron memory cells to enable one or more models indicated in the knowledge base to operate. This allows the set of neuron memory cells to react to the one or more models indicated in the knowledge base. The one or more models can correspond to the function.

In a variation on this embodiment, the controller can be a hardware module programmable based on the configuration file, and the set of neuron memory cells can establish a silicon neural network for executing the pattern recognition operation.

In a variation on this embodiment, the function can be content generation. The cognitive memory can then execute the pattern matching operation based on a piece of data stored in the storage memory and analyze the piece of data in the cognitive memory based on the execution of the pattern matching operation. Subsequently, the controller generates a piece of content for the piece of data based on the analysis.

In a variation on this embodiment, the function can be selective retrieval. The cognitive memory can then execute the pattern matching operation based on a piece of data stored in the storage memory and determine whether the piece of data is recognized by the cognitive memory. Subsequently, the controller determines whether to retrieve the piece of data from the storage memory based on the recognition.

In a variation on this embodiment, the function can be selective recording. The cognitive memory can then execute the pattern matching operation based on a piece of data received by the apparatus and determine whether the piece of data is recognized by the cognitive memory. Subsequently, the controller determines whether to store the piece of data in the storage memory based on the recognition.

In a variation on this embodiment, the system also includes a non-volatile cache memory, which can temporarily store data for operations of the controller.

### BRIEF DESCRIPTION OF THE FIGURES

FIG. 1A illustrates an exemplary infrastructure based on storage nodes with cognitive storage devices (CSDs), in accordance with an embodiment of the present application.

FIG. 1B illustrates an exemplary architecture of a CSD, in accordance with an embodiment of the present application.

FIG. 2A illustrates an exemplary architecture of a neuron, in accordance with an embodiment of the present application.

FIG. 2B illustrates exemplary operations of a neuron, in accordance with an embodiment of the present application.

FIG. 3A illustrates an exemplary dataflow of selective recording in a CSD, in accordance with an embodiment of the present application.

FIG. 3B illustrates an exemplary dataflow of selective retrieval from a CSD, in accordance with an embodiment of the present application.

FIG. 3C illustrates an exemplary dataflow of content generation within a CSD, in accordance with an embodiment of the present application.

FIG. 4 illustrates an exemplary knowledge transfer to a CSD, in accordance with an embodiment of the present application.

FIG. 5A presents a flowchart illustrating a selective recording method of a CSD, in accordance with an embodiment of the present application.

FIG. 5B presents a flowchart illustrating a selective retrieval method of a CSD, in accordance with an embodiment of the present application.

FIG. 5C presents a flowchart illustrating a content generation method of a CSD, in accordance with an embodiment of the present application.

FIG. 5D presents a flowchart illustrating a query response method of a CSD for generated content, in accordance with an embodiment of the present application.

FIG. 6 illustrates an exemplary computer system that facilitates a CSD, in accordance with an embodiment of the present application.

FIG. 7 illustrates an exemplary apparatus that facilitates a CSD, in accordance with an embodiment of the present application.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the embodiments described herein are not limited to the embodiments shown, but are to be accorded the widest scope consistent with the principles and features disclosed herein.

### Overview

The embodiments described herein solve the problem of efficiently executing storage operations in a storage device by incorporating (i) a cognitive memory comprising neuron memory cells; and (ii) a neuromorphic search engine capable of running queries on incoming data or already stored data using the cognitive memory without transferring the data outside of the storage device. The neuron memory cells, which are also referred to as neurons, can combine memory and recognition logics.

With existing technologies, SSDs are not typically equipped with in-situ processing capabilities. As a result, any analysis performed on the data stored in its memory implies its transfer, at least in part, to a host device. The analysis then occupies the processing cycle of the processors of the host device. If the analysis generates any result and/or metadata, the host device can transfer the result and/or metadata back to the memory of the SSD. Such operations can be processing-intensive and, hence, may negatively affect device performance and lead to high power consumption. Even when an SSD with in-situ processing capabilities emerges, the underlying Von-Neumann architecture relies on parallel processing units and tree search algorithms. The analysis of a large amount of data stored on the SSD using a large variety of models based on such existing architecture leads to significant power consumption. Consequently, such SSD architecture may not be viable for many consumer appliances and infeasible for portable appliances.

To solve this problem, embodiments described herein provide a cognitive storage device (CSD) that includes a cognitive storage controller and three memory blocks: a storage memory, a cognitive memory, and a cache. The storage memory can facilitate the storage capability of the storage device. On the other hand, the cognitive memory can operate as a pattern learning and matching accelerator. The cache can include a non-volatile memory and facilitate a working memory that temporarily stores data for the operations of the controller. The controller can facilitate communication between the three memory blocks and a host computing device via a host interface. The host interface can include one or more communication modules that allow data exchange to and from the CSD.

The storage memory can be based on one or more of: a read-only memory (ROM); a NAND-based flash memory; magnetic RAM (read-only memory) (MRAM); spin torque (ST) MRAM; resistive RAM (ReRAM); transistor-less memory, such as 3D XPoint; and other chemical or magnetic memory (e.g., with symmetrical read and write time). The controller can be based on one or more of: an embedded processor, field-programmable gate array (FPGA), and custom application-specific integrated circuit (ASIC), which can execute firmware-level code. The host interface can be based on one or more of: peripheral component interconnect express (PCIe), Compute Express Link (CXL), serial attached SCSI (small computer system interface) (SAS), serial ATA (AT Attachment) (SATA), universal serial bus (USB), Wi-Fi®, Bluetooth®, and cellular communication.

The cognitive memory can include neuron memory cells that can be referred to as neurons. A neuron combines memory, and recognition and learning logic. The architecture, operations, and capabilities of a neuron are specified in the U.S. Pat. No. 5,740,326, titled “Circuit for Searching/Sorting Data in Neural Networks,” by inventors Jean-Yves Boulet, Pascal Tannhof, and Guy Paillet, granted 14 Apr. 1998, the disclosure of which is incorporated herein in its entirety. The neurons in the cognitive memory are identical and interconnected (e.g., regardless of their number). Therefore, the neurons can operate in parallel without needing a separate entity to learn or recognize input data.

During operation, upon receiving data via the host interface, the controller manages the delivery of the data to the memory blocks by executing an application-specific search engine. For example, the search engine can determine whether to perform a read or write operation based on a query corresponding to a pattern matching operation. The search query can perform a pattern matching operation by searching for an incoming pattern in the data stored in the CSD. The pattern matching operation is executed by the search engine using a knowledge base defined in the cognitive memory. The knowledge base can be configured locally on the CSD, or on a remote training platform and transferred to the CSD. In addition to facilitating the search engine, the controller can also perform the operations of the controller of an SSD. For example, the controller can manage the storage memory by performing one or more of: error correction, wear leveling, bad-block mapping, read scrubbing, read disturb management, read and write caching, garbage collection, and encryption.

The cognitive memory uses the knowledge base to provide a fully parallel silicon neural network comprising a chain of neurons capable of processing information simultaneously. The neurons can be daisy-chained to compose a chain of neurons. However, each neuron can be addressed and accessed in parallel. As a result, the neurons can learn information and recall that learned information autonomously without decoding instructions and external reporting. In addition, the neurons collaborate with each other through a bi-directional and parallel neuron bus. Each neuron incorporates information from the other neurons into its own learning logic and into its response logic. This mechanism facilitates self-sorting of the firing neurons and triggering their response per increasing distances. This mechanism also prevents the learning of any redundant information, but also enables the immediate detection of novelty or potential conflicts.

The CSD can perform a reactive search of an incoming pattern by providing the search query corresponding to the pattern matching operation to all neurons in parallel. A respective neuron can then calculate the distance between an input and a prototype piece of data (e.g., a portion of the knowledge base) stored in the neuron's memory. The aggregate distances for the firing neurons in a network of neurons can then be used to determine the minimum distance and select the best matched neuron, or to determine a single output based on a function described in the configuration file. Using the silicon neural network provided by the cognitive memory, the CSD can perform a number of operations, thereby providing a number of functionalities within the CSD. The parallel nature of the neurons allows the CSD to perform an operation within a constant time (i.e., independent of the data size). In addition, since a respective neuron requires very low power, the overall power consumption of the cognitive memory can be very low (e.g., less than 5 watts peak for 10 thousand neurons). In this way, the CSD facilitates high-efficiency execution of operations within the CSD with low power consumption.

### Exemplary System

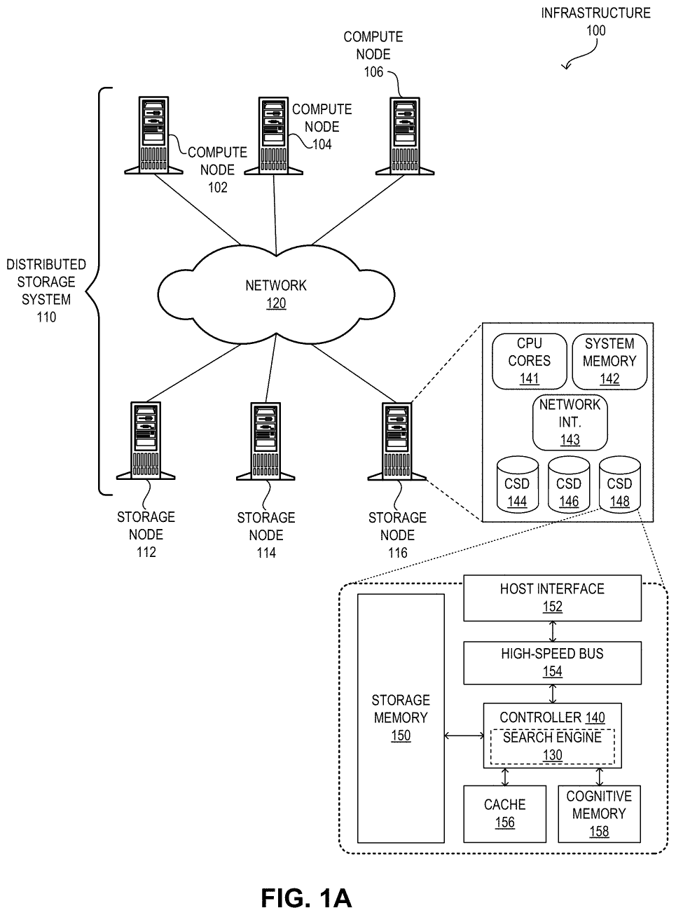

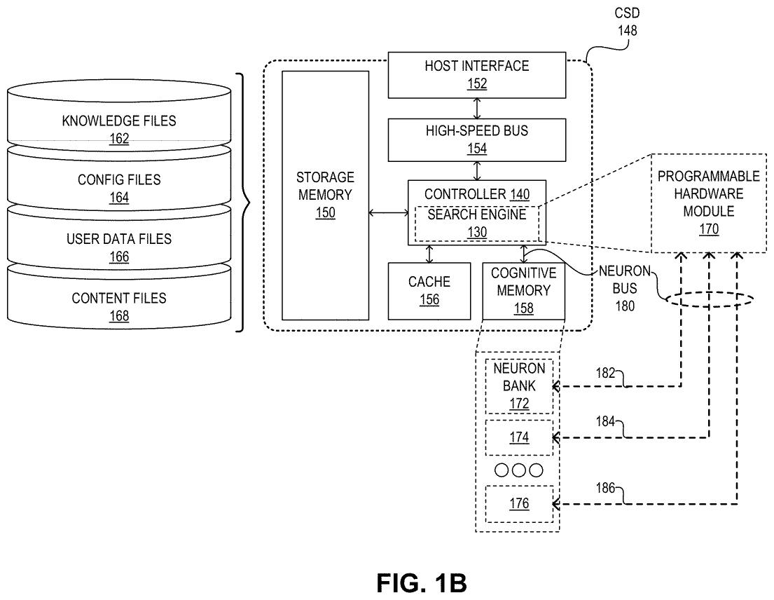

FIG. 1A illustrates an exemplary infrastructure based on storage nodes with cognitive storage devices (CSDs), in accordance with an embodiment of the present application. In this example, an infrastructure 100 can include a distributed storage system 110 (e.g., a datacenter). System 110 can include a number of compute nodes (or user-serving machines) 102, 104, and 106, and a number of storage nodes 112, 114, and 116. Compute nodes 102, 104, and 106, and storage nodes 112, 114, and 116 can communicate with each other via a network 120 (e.g., a local or a wide area network, such as the Internet). A storage node can also include multiple storage devices. For example, storage node 116 can include components such as a number of central processing unit (CPU) cores 141, a system memory device 142 (e.g., a dual in-line memory module), a network interface card (NIC) 143, and a number of storage devices/disks 144, 146, and 148.

With existing technologies, storage devices/disks 144, 146, and 148 can be SSDs, which are not typically equipped with in-situ processing capabilities. As a result, any analysis performed on the data stored in storage device 148 needs transfer of data, at least in part, to memory 142 of storage node 116. The analysis then occupies the processing cycle of CPU cores 141. If the analysis generates any result and/or metadata in memory 142, CPU cores 141 uses interrupts to transfer the result and/or metadata from memory 142 back to storage device 148. Such operations can be processing-intensive and, hence, may negatively affect device performance and lead to high power consumption in storage node 116. Even if storage device 148 is equipped with in-situ processing capabilities, the underlying Von-Neumann architecture relies on parallel processing units and tree search algorithms. The analysis of a large amount of data stored on storage device 148 using a large variety of models based on such existing architecture leads to significant power consumption. Consequently, such architecture may be infeasible for deployment in system 110.

To solve this problem, storage device 148 can be a CSD, which includes a cognitive storage controller 140 and three memory blocks: a cognitive memory 158, a storage memory 150, and a cache 156. Storage memory 150 can facilitate the storage capability of storage device 148. On the other hand, cognitive memory 158 can operate as a pattern learning and matching accelerator. Cache 156 can include a non-volatile memory and facilitate a working memory that temporarily stores data for the operations of controller 140. Controller 140 can facilitate communication among the three memory blocks. Storage node 116 can communicate with storage device 148 via a host interface 152 through a high-speed bus 154.

During operation, upon receiving data via host interface 152, controller 140 manages the delivery of the data to the memory blocks by executing an application-specific search engine 130 (e.g., a hardware-based search engine). Based on a specific operation, controller 140 can configure a corresponding search engine 130. For example, search engine 130 can determine whether to perform a read or write operation based on a search query corresponding to a pattern matching operation, and controller 140 can configure search engine 130 accordingly. The pattern matching operation is executed by search engine 130 using a knowledge base defined in cognitive memory 158. In other words, the query is translated into a configuration residing in search engine 130 and a knowledge residing in the neurons of cognitive memory 158. Search engine 130 then accesses the associated user data in storage memory 150 and classifies the data based on the configuration and the knowledge base in cognitive memory 158.

The knowledge base can be configured locally on storage device 148, or on a remote training platform and transferred to storage device 148. In addition to facilitating search engine 130, controller 140 can also perform the operations of the controller of an SSD. For example, controller 140 can manage storage memory 150 by performing one or more of: error correction, wear leveling, bad-block mapping, read scrubbing, read disturb management, read and write caching, garbage collection, and encryption. In some embodiments, storage device 148 can be enclosed in a standard disk drive enclosure, such as a 2.5 inch or 3.5 inch format, that allows easy hot insertion into and removal from storage node 116 (e.g., from a redundant array of independent disks (RAID)). Storage device 148 can also be implemented on a printed circuit board (PCB) with the M.2 (also referred to as next generation form factor (NGFF)) format, and can be integrated into a USB adaptor or an industrial U.2 adaptor.

Storage device 148 can support a number of functionalities, such as content (e.g., metadata and/or table of content) generation, selective retrieval, and selective storage. Storage device 148 can execute a corresponding search query to facilitate each of these functionalities. To generate content, controller 140 can configure search engine 130 accordingly, and load the corresponding knowledge files into cognitive memory 158. In some embodiments, storage device 148 can store the configurations of search engine 130 and the knowledge files for cognitive memory 158 in storage memory 150. Controller 140 then receives a search query for an incoming pattern through data bus 154 and executes the search query for a corresponding pattern matching operation on search engine 130.

Controller 140 can deliver the content generated from the data matching the search query through the same data bus 154, and/or store the generated content in a dedicated location in storage memory 150. Examples of the generated content can include, but are not limited to, a dictionary of filenames matching a topic described in the knowledge base, a table of occurrences of words or expressions in a text, a list of recognized faces across multiple movie files and their timestamps, and a list of abnormal noises in a series of audio files.

To facilitate selective retrieval, storage device 148 can receive a search query via host interface 152. The search query can include a piece of data (e.g., an incoming pattern) associated with the search query. Controller 140 can configure search engine 130 with a configuration associated with the selective retrieval, and load the corresponding knowledge files into cognitive memory 158. Controller 140 can then execute the search query for a corresponding pattern matching operation on search engine 130 using cognitive memory 158. If a piece of data matches the search query, controller 140 can deliver the data matching the search query from storage memory 150 through data bus 154 via host interface 152.

To facilitate selective storage (i.e., selective recording), storage device 148 can receive a search query via host interface 152. The search query can include a piece of data to be stored. Controller 140 can configure search engine 130 with a configuration associated with the selective storage, and load the corresponding knowledge files into cognitive memory 158. Controller 140 can then execute the search query for a corresponding pattern matching operation on search engine 130 using cognitive memory 158. If a piece of data (e.g., a predefined pattern) matches the search query, controller 140 can store the piece of data to storage memory 150. It should be noted that controller 140 can transition from one function to another by loading a different configuration file. As a result, storage device 148 may operate based on one functionality for a period of time, and then switch to another one. Storage node 116 can instruct controller 140 to transition via host interface 152.

In this way, a functionality can be enabled in storage device 148 based on the configuration of search engine 130 and the knowledge files of cognitive memory 158. The configuration can include one or more specializations associated with the functionality. A respective specialization can include a feature space, such as categories and/or characteristics, and a setting indicating an operational level. An operational level can indicate how aggressively or conservatively the function is executed. Based on the specializations of the configuration, search engine 130 can extract features or signatures from the data stored temporarily in cache 156 to relate to the formats of the models stored in the knowledge files and loaded in the neurons of cognitive memory 158 (i.e., in the neuron memory cells). The models can facilitate the functionalities associated with the configuration.

For example, a specialization can be directed to the semantic analysis and parsing of words/expressions from a string of words. In another example, a specialization can be directed to visual objects and extracting a feature or a signature from an image. A configuration can also include a plurality of specializations (e.g., image data, audio data). Multiple specializations can be used to extract multiple features from a same data type to obtain a more detailed description and possible discrimination of the data type (e.g., color, edge and texture of a visual object; signal sampling at 10, 100 and 10,000 Hz).

FIG. 1B illustrates an exemplary architecture of a CSD, in accordance with an embodiment of the present application. Search engine 130 can include a programmable hardware module 170, which can be a configurable piece of hardware capable of accessing storage memory 150, at least in part, to search for reference patterns loaded in cognitive memory 158. Module 170 can execute firmware-level codes, and operate as a interface logic between storage memory 150, cognitive memory 158, cache 156, and the host (i.e., storage node 116). In some embodiments, module 170 can be an FPGA-based module coupled to cognitive memory 158. Module 170 can be based on one or more of: integrated circuitry, and a semiconductor intellectual property (IP) core. Cognitive memory 158 can include a neuron-based integrated circuit and/or a semiconductor IP core arranged as a single memory bank or a plurality of neuron banks 172, 174, and 176. The components of cognitive memory 158 may be coupled via a PCB, or on multiple chips. Module 170 and cognitive memory 158 can also be parts of an integrated circuit on a common substrate (e.g., on the same die).

Cognitive memory 158 includes a number of neurons distributed across neuron banks 172, 174, and 176. In each of the neuron banks, the neurons can be daisy-chained to compose a chain of neurons. However, each neuron in each neuron bank can be addressed and accessed in parallel. As a result, the neurons can learn information and recall that learned information autonomously without decoding instructions and external reporting. In addition, the neurons collaborate with each other through a bi-directional and parallel neuron bus 180. In this example, neuron bus 180 can include a number of parallel buses 182, 184, and 186, coupling neuron banks 172, 174, and 176, respectively, to module 170.

Each neuron of neuron bank 172 incorporates information from the other neurons in neuron bank 172 into its own learning logic and into its response logic. This mechanism prevents the learning of any redundant information, but also enables the immediate detection of novelty or potential conflicts. In this way, cognitive memory 158 facilitates one or more fully parallel silicon neural networks. For example, each of neuron banks 172, 174, and 176 can provide a silicon neural network capable of facilitating distinct operations. Each neuron in neuron bank 172 can also be configured to incorporate information from the other neurons in neuron banks 174 and/or 176, if needed. A corresponding neural network can then span multiple neuron banks.

Since storage device 148 is used for storing user data, storage memory 150 also includes user data files 166. In addition, each silicon neural network uses a knowledge base to perform the corresponding search operation. A set of knowledge files 162 can represent the knowledge base. A set of knowledge files can facilitate a corresponding functionality of storage device 148. A portion of storage memory 150 can be used for storing knowledge files 162. Another portion of storage memory 150 can be used for storing configuration files 164. To enable a corresponding functionality, controller 140 can load a configuration file on module 170. That configuration file enables a particular type of search engine 130.

For example, to enable the functionality of selective retrieval from user data files 166, controller 140 can load the corresponding configuration file of configuration files 164 on module 170 to provide search engine 130. Controller 140 also loads a set of knowledge files of knowledge files 162 that provides the “knowledge” (e.g., the reference patterns) on cognitive memory 158. Search engine 130 then performs search queries on user data files 166 for selective retrieval using the set of knowledge files. Similarly, if the functionality of content generation is enabled, the search queries can be executed on user data files 166 for content generation using the corresponding set of knowledge files of knowledge files 162. By executing the search queries, search engine 130 can generate content files 168 (e.g., table of content, index, and/or metadata associated with user data files 166). Controller 140 can then store content files 168 in storage memory 150.

In some embodiments, storage memory 150 can be divided into a number of zones. Knowledge files 162, configuration files 164, user data files 166, and content files 168 can be stored in their respective zones. The size (i.e., the storage capacity) of a zone can be determined based on the size of the files stored in that zone. For example, since storage device 148 is expected to store a large amount of user data, the zone for user data files 166 can be significantly larger than other zones. Furthermore, controller 140 can adjust the size of a zone based on the size of the files stored in that zone.

Storage device 148 can perform a reactive search by providing the search query for the pattern matching operation to all neurons in parallel. A respective neuron can then calculate the distance between an input and a prototype piece of data (e.g., a portion of knowledge files 162) stored in a neuron's memory. The aggregate distances for the neurons in a network of neurons can then be used to determine the minimum distance and select the best matched neuron. Using the silicon neural network provided by cognitive memory 158, storage device 148 can perform a number of functions within storage device 148. The parallel nature of the neurons allows storage device 148 to perform a search query for a pattern within a constant time (i.e., independent of the size of the knowledge files or the number of models stored in the neurons of cognitive memory 158).

To execute the pattern matching operation of the search query, each neuron in cognitive memory 158 autonomously compare the data associated with the search query (e.g., an incoming pattern) with the pattern held in the memory of the neuron. Upon identifying a match (e.g., exact or fuzzy), the neuron fires and becomes ready to submit its response (e.g., an output of the pattern matching operation) to provide a global coordinated decision in its neuron bank or in cognitive memory 158. The neuron can fire if the distance between the data and the stored pattern is smaller than the influence field of the neuron. If multiple neurons are fired for the data of the search query, the neuron with the most confidence (i.e., the smallest distance) can trigger and submit its response as the collaborative response from cognitive memory 158. The triggering causes a readout and/or a release of the pattern stored the memory of the neuron. In a different configuration, search engine 130 can aggregate the response of the K closest firing neurons to produce a single category output based on the application of a rule-based function or on the use of another neural network. In addition, if the search query includes a new pattern or a learning instruction is issued for the pattern, the committed neurons in cognitive memory 158 collectively determine whether a new neuron should be committed (or allocated) to hold the new pattern.

### Neurons

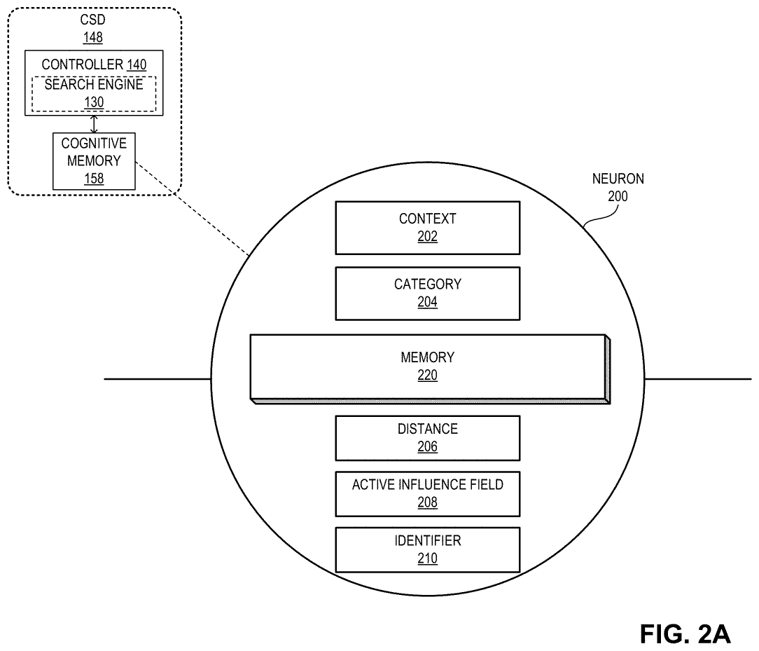

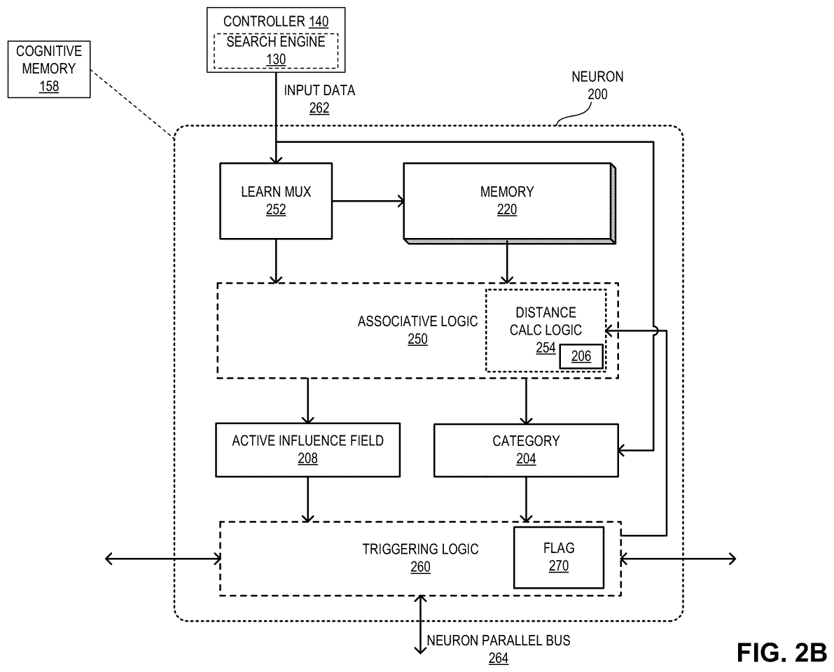

FIG. 2A illustrates an exemplary architecture of a neuron, in accordance with an embodiment of the present application. Cognitive memory 158 can include a neuron 200. A respective neuron of cognitive memory 158 can be identical to neuron 200. Neuron 200 can include a memory 220, and a number of registers, which includes one or more of: a context register 202, a category register 204, a distance register 206, an active influence field (AIF) register 208, and an identifier 210. Memory 220 can store the pattern that triggers the initial commit of neuron 200. This pattern can be referred to as the reference pattern. For example, if a neural network is trained to recognize an image (e.g., a number), and neuron 200 is committed to a particular type of pattern (e.g., a “7”), memory 220 can store that pattern. In this way, neuron 200 can correspond to a node of in the hidden layer of the neural network.

Context register 202 identifies a type of input (or stimuli) for which neuron 200 should trigger. Context register 202 allows multiple silicon neural networks to operate in cognitive memory 158. For example, if cognitive memory 158 holds two neural networks for visual and auditory processing, context register 202 can indicate whether neuron 200 should be triggered for a visual input or an auditory input. In another example, cognitive memory 158 can hold two neural networks, both of which can be used for the recognition of identical visual objects but trained on different feature spaces, such as color, texture, and edges. Category register 204 indicates the category of the pattern stored in memory 220. For example, if a set of neurons of cognitive memory 158 are committed for different styles of writing a “7” (i.e., store different patterns of “7”), the category registers of these neurons can indicate that they are for recognizing a “7.” Consequently, if neuron 200 is a part of the set of neurons, category register 204 can indicate that neuron 200 is committed to recognize a “7.” Category register 204, thus, allows multiple neurons of the silicon neural network to hold different patterns of the same output. In this way, the silicon neural network can be formed with a single hidden layer.

Since memory 220 of neuron 200 operates as both cognitive and reactive memory, neuron 200 can autonomously evaluate the distance between an incoming pattern from an input data and the reference pattern stored in memory 220 and store the distance in distance register 206. If this distance falls within a range indicated by the influence field specified in AIF register 208, neuron 200 returns a positive classification that includes the distance value from distance register 206 and category of the reference pattern from category register 204. Neuron 200 has the capability to observe the response of other neurons of cognitive memory 158 to establish a collective response, and withdraws itself if another neuron reports a smaller distance value. Identifier register 210 can include an identifier that can uniquely identify neuron 200 among all neurons in cognitive memory 158.

Memory 220, context register 202, and category register 204 are written when neuron 200 is committed. On the other hand, distance register 206 can be adjusted by neuron 200 during the pattern evaluation. AIF register 208 can be adjusted by neuron 200 during a pattern learning. Neuron 200 fires if the distance between an input pattern and the reference pattern of the “7” stored in memory 220 is within the value indicated by AIF register 208. If neuron 200 has the smallest distance compared to other firing neurons of cognitive memory 158, neuron 200 is triggered, which causes neuron 200 to first output its response to search engine 130 indicating that the input pattern is a 7. The triggering also causes neuron 200 to releases its “firing” status, which allows the second closest neuron of the firing neurons to output its response, if applicable. In this way, multiple neurons in cognitive memory 158 can be triggered, and output their respective responses based on an increasing order of distance and report identical category of the same digit “7.”. If there is an uncertainty, the triggered neurons can indicate categories different than the category of the digit “7.”

Any input can be broadcast to a respective neuron in cognitive memory 158. Neuron 200 can match an input pattern against the reference pattern stored in memory 220 in a constant time. Since each neuron in cognitive memory 158 can receive the input pattern in parallel and is triggered only if its distance is the smallest, cognitive memory 158 can execute a search query in that constant time. The latency for executing the search query on cognitive memory 158 can be in the order of microseconds regardless of the size of the search space. The execution of the search query can be based on exact or fuzzy-logic matching. Cognitive memory 158 thus can operate at a high speed. For example, if cognitive memory 158 includes 1000 neurons, the parallel execution of a single clock cycle by cognitive memory 158 can be the equivalent of 4,000 CPU instructions related to search without fetch/decode.

In addition, if any of the reference patterns of cognitive memory 158 does not match a query and search engine 130 requests a learning, an uncommitted neuron can be committed for that pattern in that constant time. As a result, cognitive memory 158 can dynamically learn new patterns in constant time. This allows cognitive memory 158 to automatically generate a new model to learn a new pattern and store the pattern in the next available neuron. Furthermore, since the neurons of cognitive memory 158 can operate independently of and in collaboration with each other, cognitive memory 158 can include any number of neurons. Since neuron 200 can operate at a low frequency and draw low current, cognitive memory 158 can operate with ultra-low power and may not incur significant heating.

The neurons in cognitive memory 158 are daisy-chained to compose a chain of neurons. At initialization, all neurons in cognitive memory 158, including neuron 200, can be uncommitted or empty (i.e., may not include any knowledge). Suppose that neuron 200 is the first neuron available. All neurons in cognitive memory 158 are then dormant except neuron 200, which can be ready to learn. When a new pattern arrives, neuron 200 then stores that pattern. If instructed to learn the pattern by the search engine 130 (or another controller), neuron 200 writes the input category to category register 204 and becomes committed. Neurons in cognitive memory 158 are progressively committed by storing an incoming pattern in the associated category. Therefore, at least one neuron in cognitive memory 158 can be in a ready-to-learn state, unless all neurons have been committed.

The state of neuron 200 is indicated by the status of its daisy-chain-in (DCI) and daisy-chain-out (DCO) lines. The DCO of neuron 200 rises if its DCI is high and category register 204 includes a non-zero value. As a result, the commitment of neurons is propagated automatically through the daisy chain as new patterns are taught and retained. The ready-to-learn neuron moves from the first position of the chain to the last position until there are no more dormant neurons available in the chain.

FIG. 2B illustrates exemplary operations of a neuron, in accordance with an embodiment of the present application. During operation, controller 140 can provide input data 262 to neuron 200. Input data 262 is a piece of data. Neuron 200 can include a learn multiplexer 252 that divides and transmits the multiplexed input data 262 into memory 220 and an associative logic 250. Memory 220 can also be referred to as a recall memory since it stores the pattern for which neuron 200 has been committed. Memory 220 then processes input data 262 and outputs processed signals to associative logic 250. If neuron 200 is in a ready-to-learn state, neuron 200 can learn the pattern in input data 262 by storing the pattern in memory 220 and associate the pattern loaded in memory 210 with a category held in category register 204. On the other hand, if neuron 200 is in a committed state, memory 220 has already learned the reference pattern.

Suppose that neuron 200 is in a committed state. During the recognition phase, an incoming pattern in input data 262 is sent to all neurons in cognitive memory 158 simultaneously over a neuron parallel bus 264. When the incoming pattern enters neuron 200, learn multiplexer 252 transmits the pattern to associative logic 250. A distance calculation logic 254 then determines the distance between the incoming pattern and the reference pattern in memory 210, and stores the distance in distance register 206. If the distance in distance register 206 is less than or equal to a threshold specified in AIF register 208, neuron 200 is triggered (or excited).

Neuron 200 then sends a signal through triggering logic 260 and set a firing flag 270. A set state for flag 270 can indicate that neuron 200 has been fired, and hence, is ready to output a positive response if its distance is the smallest among the firing neurons. Neuron 200 then outputs the category of the reference pattern to neuron parallel bus 264 via triggering logic 260 and releases its flag 270. If multiple neurons are triggered for input data 262, triggering logic 260 compares the distance and category information among the firing neurons. If triggering logic 260 determines that the distance in distance register 206 is not the smallest distance, triggering logic 260 precludes (or inhibits) neuron 200 from triggering. In this way, the firing neuron that provides the smallest distance (i.e., the best match) between the incoming pattern in input data 262 and its reference pattern can return a result to controller 140.

Suppose that neuron 200 is in a ready-to-learn state. During the learning phase, neuron 200 can become engaged by loading an incoming pattern in input data 262 into memory 220, thereby learning the incoming pattern. If no other neuron is triggered, engaged neuron 200 can become a committed neuron by committing the incoming pattern in memory 220 and storing the associated category in category register 204. AIF register 208 is then set to a maximum value of the AIF. On the other hand, if other neurons are triggered, engaged neuron 200 can become a committed neuron 200 if none of the other triggered neurons identifies the incoming pattern as belonging to a category to learn (e.g., a category corresponding to the learning phase). AIF register 208 is then set to the distance of the neuron with the smallest distance value.

Suppose that neuron 200 is triggered even though the category indicated by category register 204 is different than the category to learn. For example, the category to learn can be associated with the pattern of “8” while the category indicated by category register 204 can be associated with the pattern of “7.” Neuron 200 can then reduce the influence field value of AIF register 208 to a distance value between the reference pattern stored in memory 220 and the incoming pattern in input data 262. The reduction of the influence field is a corrective action that prevents neuron 200 from firing if the same incoming pattern is received again. This causes knowledge modification or adaptive learning. This learning phase refines the similarities between the reference pattern and the incoming pattern, and shrinks the corresponding influence field.

### Functionalities

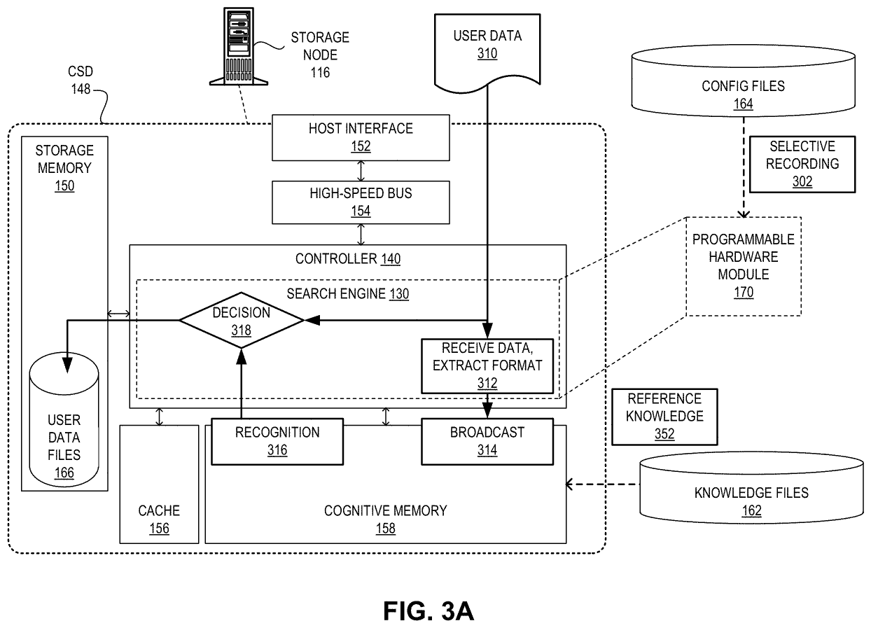

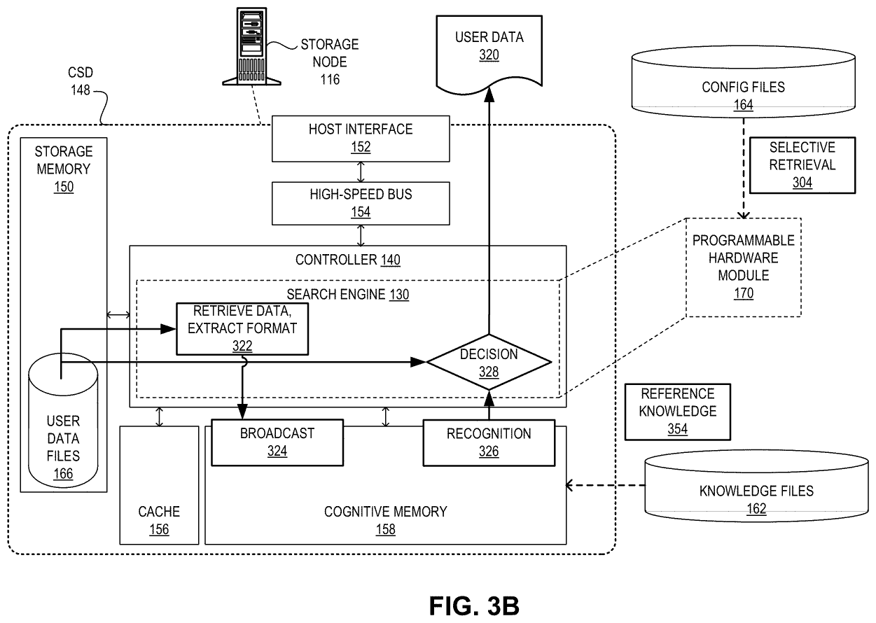

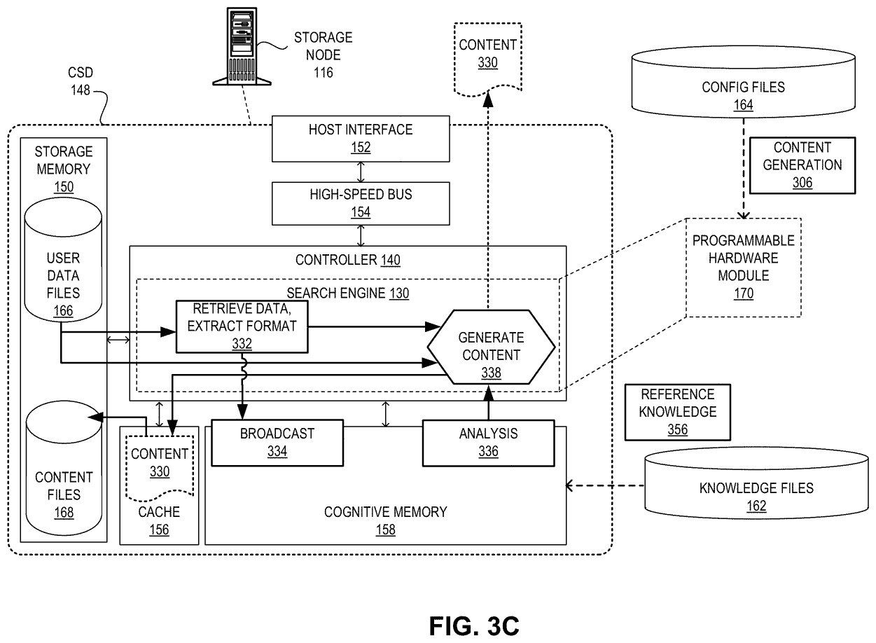

Controller 140 can provide configurable instructions for a number of functionalities that can be incorporated within storage device 148. Examples of the functionalities include, but are not limited to, selective recording, selective retrieval, and content generation. FIG. 3A illustrates an exemplary dataflow of selective recording in a CSD, in accordance with an embodiment of the present application. During operation, controller 140 can load a selective recording configuration 302 into module 170 to enable the corresponding search engine 130 (e.g., based on the requirement of an application). Configuration 302 allows controller 140 to issue and execute instructions for performing the selective storage. Controller 140 can receive user data 310 from storage node 116, which is the host device of storage device 148, via host interface 152. Controller 140 then extracts the format of data 310 (operation 312). For example, controller 140 may extract words from a string of words, or a feature or a signature from an image.

Controller 140 then broadcasts the extracted format to the neurons of cognitive memory 158 in parallel (operation 314). Cognitive memory 158 can store reference knowledge base 352 (e.g., one or more knowledge files) associated with configuration 302 from knowledge files 162 for comparing with the extracted format. In some embodiments, controller 140 can store data 310 in cache 156 prior to broadcasting data 310 from cache 156 to cognitive memory 158. Cognitive memory 158 then determines whether the pattern in data 310 is recognized by cognitive memory 158 (operation 316). The recognition operation can be based on whether the pattern in data 310 matches a reference pattern of at least one of the neurons. Controller 140 can decide whether to write data 310 to storage memory 150 based on the recognition (operation 318) and can issue a write instruction accordingly.

For example, if the application is associated with text analysis, reference knowledge base 352 can represent words that indicate a sentiment (e.g., happiness, frustration, and unhappiness). Suppose that data 310 includes a text post. When controller 140 broadcasts data 310 to cognitive memory 158, cognitive memory 158 can determine that the text post indicates frustration. To do so, a neuron in cognitive memory 158 that includes a reference pattern of frustration can be triggered by the pattern in data 310. Based on the determination, controller 140 provides a write instruction to store the text post to storage memory 150. In another example, reference knowledge base 352 includes reference faces for facial recognition. Suppose that data 310 includes an image of a face. When controller 140 broadcasts data 310 to cognitive memory 158, and cognitive memory 158 determines that the face in data 310 matches a reference face, controller 140 can provide a write instruction to store the image in data 310 to storage memory 150.

FIG. 3B illustrates an exemplary dataflow of selective retrieval from a CSD, in accordance with an embodiment of the present application. During operation, controller 140 can load a selective retrieval configuration 304 into module 170 to enable the corresponding search engine 130. Controller 140 can retrieve user data 320 from storage memory 150 and extract the format of user data 320 (operation 322). Controller 140 then broadcasts the extracted format to cognitive memory 158 (operation 324). Cognitive memory 158 can store reference knowledge base 354 (e.g., one or more knowledge files) associated with configuration 304 from knowledge files 162 for comparing with the extracted format. Cognitive memory 158 then determines whether the pattern in data 320 is recognized by cognitive memory 158 (operation 326). Controller 140 can decide whether to provide data 320 to storage node 116 via host interface 152 based on the recognition (operation 328) and can issue a retrieval instruction accordingly.

For example, data 320 can be an audio file. Controller 140 can provide a retrieval instruction to retrieve the audio file from storage memory 150 if cognitive memory 158 determines that the audio file indicates a sound of glass breakage. In another example, data 320 can be a video frame. Controller 140 can provide a retrieval instruction to retrieve the video file from storage memory 150 and decompress/extract a video frame from the video file if cognitive memory 158 determines that a person is identified (i.e., the pattern of the video frame matches the facial patterns stored in at least one of the neurons of cognitive memory 158).

FIG. 3C illustrates an exemplary dataflow of content generation within a CSD, in accordance with an embodiment of the present application. During operation, controller 140 can load a content generation configuration 306 into module 170 to enable the corresponding search engine 130. Controller 140 can retrieve a piece of data from storage memory 150 and extract a format of the piece of data (operation 332). Controller 140 then broadcasts the extracted format to cognitive memory 158 (operation 334). Cognitive memory 158 can perform an analysis of the piece data (operation 336). Cognitive memory 158 can store reference knowledge base 356 associated with configuration 306 from knowledge files 162 for performing the analysis.

Controller 140 can then generate a piece of content 330 (e.g., a piece of metadata or a table of content) based on the analysis (operation 338). Controller 140 may store content 330 in cache 156 and/or storage memory 150. Controller 140 can, optionally, provide content 330 to storage node 116 via host interface 152. The type of content 330 can be based on the application requesting the generation of content. Examples of content 330 include, but are not limited to, a dictionary of filenames, a number of occurrences of a word in a text stream, a table of uncertainty among faces recognized in images stored in storage memory 150, and a list of anomalies in audio files.

The elements in content 330 can be sorted or unsorted since the neurons in cognitive memory 158 are accessed in parallel. For example, the unsorted elements of content 330 can be for unstructured data, such as an electrocardiogram (EKG). Controller 140 can broadcast a search query to content 330 to determine a search result. If the neurons in cognitive memory 158 do not provide a response to the search query, controller 140 can provide an instruction to store the new and unknown data from the search query to content 330 and/or storage memory 150.

### Knowledge Transfer

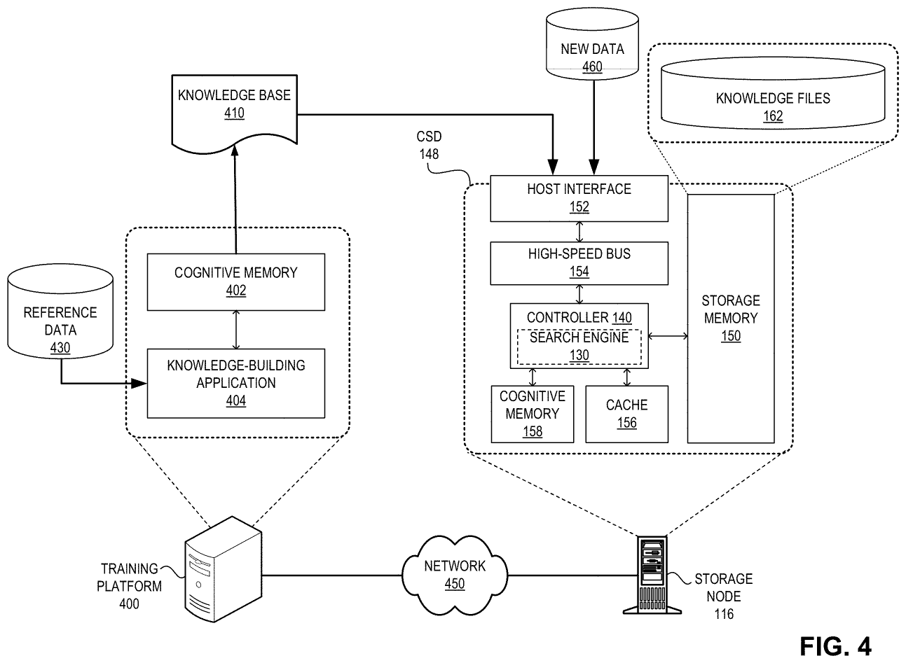

FIG. 4 illustrates an exemplary knowledge transfer to a CSD, in accordance with an embodiment of the present application. An external training platform 400 can be used for building a reference knowledge base 410 outside of storage device 148. In some embodiments, storage device 148 can also operate as the training platform to develop its knowledge base 410. Training platform 400 can be a device equipped with a cognitive memory 402 and a knowledge-building application 404. Application 404 can use reference data 430 to train the neurons in cognitive memory 402, as described in conjunction with FIGS. 2A and 2B, and establish corresponding one or more silicon neural network in cognitive memory 402. The reference information (e.g., reference patterns, category, influence field, and context) in the neurons of cognitive memory 402 corresponding to the neural network can generate a knowledge base 410.

Training platform 400 can then transfer knowledge base 410 to storage node 116 (e.g., via a network 450, which can be a wide or a local area network) at a later time. Upon receiving knowledge base 410, controller 140 can incorporate knowledge base 410 with knowledge files 162 and store in storage memory 150, and/or load knowledge base 410 in cognitive memory 158. Knowledge base 410 can then be used by an application-specific search engine 130 configured in controller 140. In addition, if the neurons in cognitive memory 158 do not provide a response to a search query, controller 140 can provide an instruction to store the new and unknown data 460 and its corresponding response in knowledge files 162. Examples of an application associated with knowledge base 410 include, but are not limited to, a facial recognition application, an audio waveform recognition application, a deoxyribonucleic acid (DNA) sequence matching application, and a customer relationship management (CRM) application.

### Operations

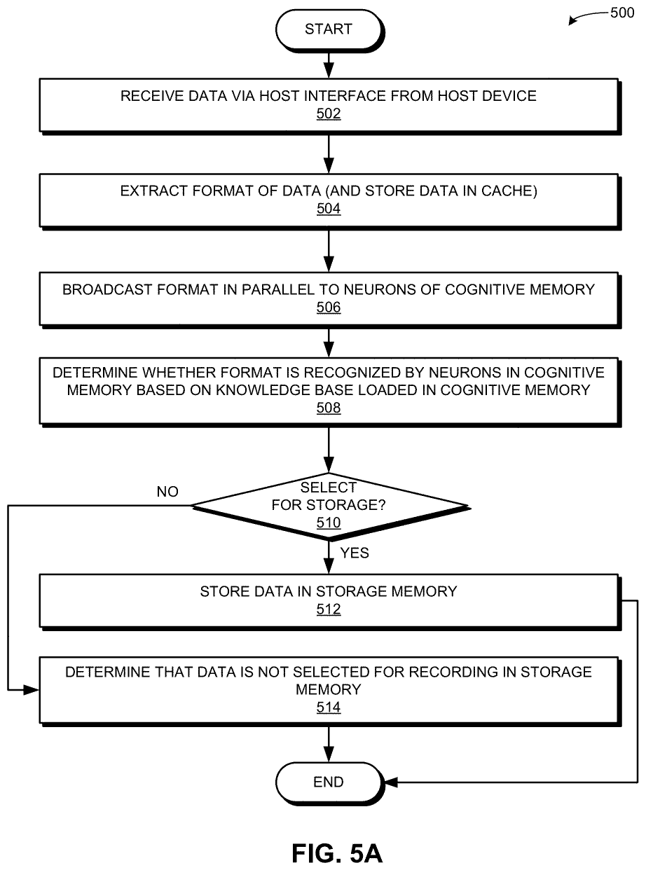

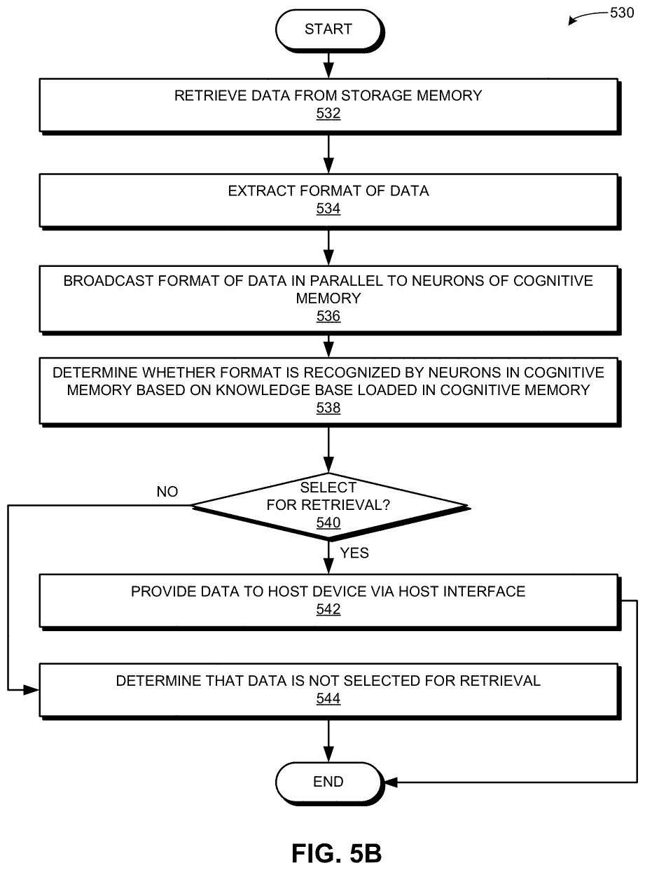

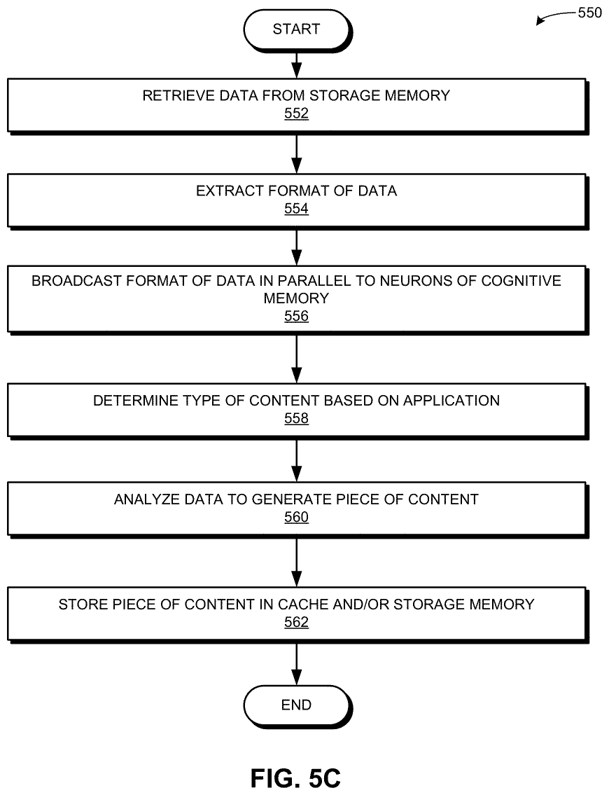

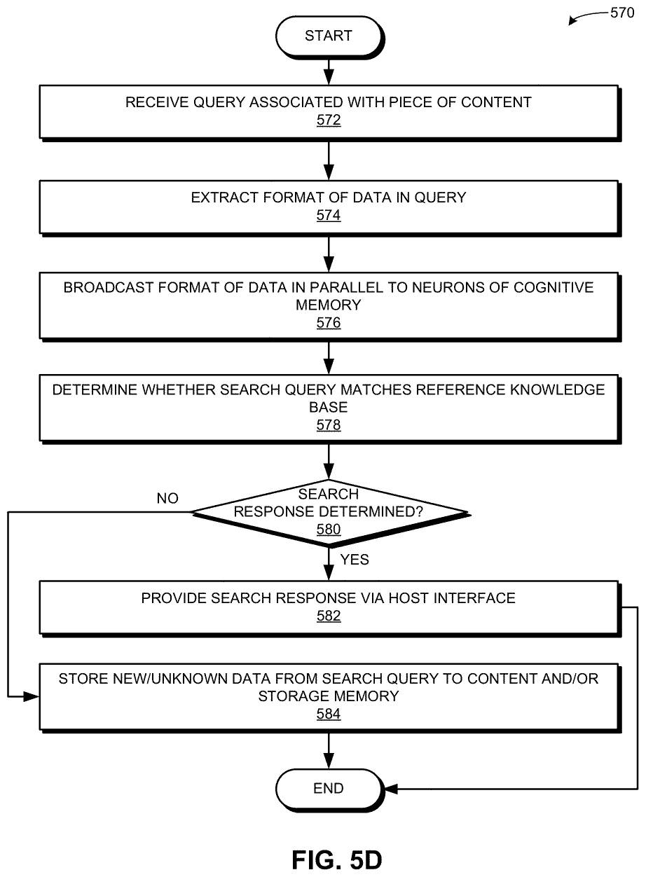

FIG. 5A presents a flowchart 500 illustrating a selective recording method of a CSD, in accordance with an embodiment of the present application. During operation, the CSD can receive data via its host interface from the host device (operation 502). The CSD then extracts the format of the data (operation 504). In some embodiments, the CSD can also store the data in its cache. The CSD then broadcasts the format in parallel to the neurons of the cognitive memory (operation 506). The CSD determines whether the format is recognized by the neurons in the cognitive memory based on a knowledge base loaded in the cognitive memory (operation 508). The CSD then determines whether the data is selected for storage (operation 510). If selected, the CSD stores the data in the storage memory of the CSD (e.g., by transferring the data from the cache) (operation 512). Otherwise, the CSD determines that the data is not selected for recording in the storage memory (operation 514).

FIG. 5B presents a flowchart 530 illustrating a selective retrieval method of a CSD, in accordance with an embodiment of the present application. During operation, the CSD can retrieve data from the storage memory (operation 532) and extract the format of the data (operation 534). The CSD then broadcasts the format in parallel to the neurons of the cognitive memory (operation 536). The CSD determines whether the format is recognized by the neurons in the cognitive memory based on a knowledge base loaded in the cognitive memory (operation 538). The CSD then determines whether the data is selected for retrieval (operation 540). If selected, the CSD can provide the data to the host device via the host interface (operation 542). Otherwise, the CSD determines that the data is not selected for retrieval (operation 544).

FIG. 5C presents a flowchart 550 illustrating a content generation method of a CSD, in accordance with an embodiment of the present application. During operation, the CSD can retrieve data from the storage memory (operation 552) and extract the format of the data (operation 554). The CSD then broadcasts the format in parallel to the neurons of the cognitive memory (operation 556). The CSD determines the type of content based on the application (operation 558). The CSD then analyzes the data to generate a piece of content (operation 560) and stores the piece of content in the cache and/or the storage memory (operation 562).

FIG. 5D presents a flowchart 570 illustrating a query response method of a CSD for generated content, in accordance with an embodiment of the present application. During operation, the CSD can receive a query associated with a piece of content (operation 572) and extract the format of the data in the query (operation 574). The CSD then broadcasts the format in parallel to the neurons of the cognitive memory (operation 576). The CSD determines whether the search query matches the reference knowledge base (operation 578). The CSD then determines whether a search response has been determined (operation 580). If determined, the CSD can provide the search response to the host device via the host interface (operation 582). Otherwise, the CSD stores the new/unknown data from the search query to the piece of content and/or the storage memory (operation 584).

### Exemplary Computer System and Apparatus

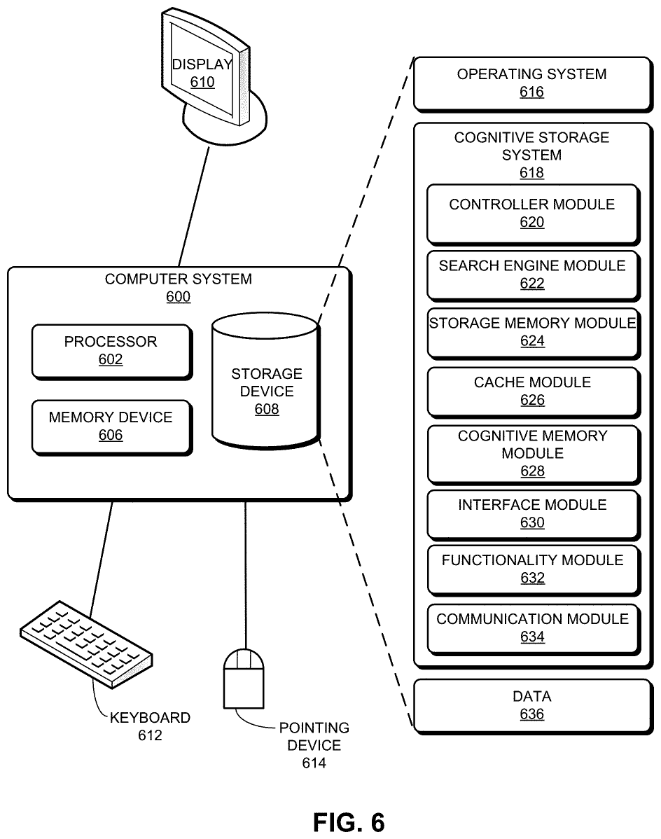

FIG. 6 illustrates an exemplary computer system that facilitates a CSD, in accordance with an embodiment of the present application. Computer system 600 includes a processor 602, a memory device 606, and a storage device 608, which can be a CSD. Memory device 606 can include a volatile memory (e.g., a dual in-line memory module (DIMM)). Furthermore, computer system 600 can be coupled to a display device 610, a keyboard 612, and a pointing device 614. Storage device 608 can store an operating system 616 and data 636. Storage device 608 can also include cognitive storage system 618. Cognitive storage system 618 can facilitate the operations of storage device 148 and its components.

Cognitive storage system 618 can also include instructions for performing methods and/or processes described in this disclosure. Specifically, cognitive storage system 618 can include instructions for facilitating communication within storage device 608 (configuration module 620). Furthermore, cognitive storage system 618 includes instructions for operating a search engine based on the loaded configuration (search engine module 622). Cognitive storage system 618 can also include instructions for configuring search engine module 622 and facilitating corresponding functions (controller module 620). Cognitive storage system 618 can also include instructions for storing data (storage memory module 624).

Moreover, cognitive storage system 618 includes instructions for temporarily storing data (cache module 626). Cognitive storage system 618 further includes instructions for facilitating one or more silicon neural networks capable of executing search queries within storage device 608 (cognitive memory module 628). Cognitive storage system 618 can also include instructions for receiving and sending data from a host device (e.g., computer system 600) (interface module 630). Cognitive storage system 618 can also include instructions for facilitating one or more functionalities in storage device 608, such as selective recording/retrieval, and content generation (functionality module 632). Cognitive storage system 618 may further include instructions for sending and receiving messages (communication module 634). Data 636 can include any data that can facilitate the operations of cognitive storage system 618, such as knowledge files, configuration files, user data files, and content files.

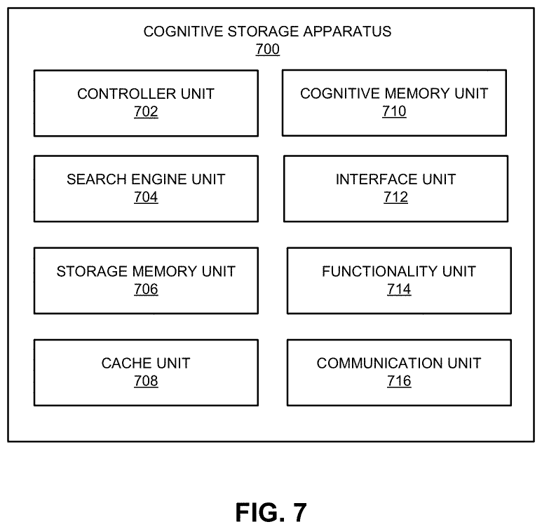

FIG. 7 illustrates an exemplary apparatus that facilitates a CSD, in accordance with an embodiment of the present application. Cognitive storage apparatus 700 can comprise a plurality of units or apparatuses which may communicate with one another via a wired, wireless, quantum light, or electrical communication channel. Apparatus 700 may be realized using one or more integrated circuits, and may include fewer or more units or apparatuses than those shown in FIG. 7. Further, apparatus 700 may be integrated in a computer system, or realized as a separate device that is capable of communicating with other computer systems and/or devices. Specifically, apparatus 700 can include units 702-716, which perform functions or operations similar to modules 620-634 of computer system 600 of FIG. 6, including: a controller unit 702; a search engine unit 704; a storage memory unit 706; a cache unit 708; a cognitive memory unit 710; an interface unit 712; a functionality unit 714; and a communication unit 716.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing embodiments described herein have been presented for purposes of illustration and description only. They are not intended to be exhaustive or to limit the embodiments described herein to the forms disclosed. Accordingly, many modifications and variations will be apparent to practitioners skilled in the art. Additionally, the above disclosure is not intended to limit the embodiments described herein. The scope of the embodiments described herein is defined by the appended claims.

What is claimed is:

1. An apparatus, comprising:
a non-volatile storage memory configured to store data;
a controller configured to program a function for the apparatus based on a configuration file, wherein the function indicates one or more operations for the data stored in the storage memory; and
a cognitive memory comprising a set of neuron memory cells,
wherein the set of neuron memory cells are configured to:
store a knowledge base for facilitating the function; and
execute a pattern matching operation between the data stored in the storage memory and data in the set of neuron memory cells; and
wherein the controller is further configured to execute the one or more operations within the apparatus based on an output of the pattern matching operation from the cognitive memory.

2. The apparatus of claim 1, wherein a neuron memory cell in the set of neuron memory cells comprises:
a recall memory configured to store a reference pattern indicated in the knowledge base; and
triggering circuitry configured to determine a distance between an incoming pattern indicated in the pattern matching operation and the reference pattern.

3. The apparatus of claim 2, wherein a respective committed neuron memory cell in the set of neuron memory cells receives the incoming pattern in parallel; and
wherein the triggering circuitry is further configured to trigger the neuron memory cell in response to the distance being the smallest distance among a set of distances, which are associated with the incoming pattern and calculated by the set of neuron memory cells.

4. The apparatus of claim 1, wherein the controller is further configured to:
select the configuration file based on a requirement of an application; and
obtain the configuration file from the storage memory.

5. The apparatus of claim 1, wherein the controller is further configured to:
obtain the knowledge base from a set of knowledge files stored in the storage memory; and
load the knowledge files to the set of neuron memory cells to enable one or more models in the knowledge base to operate, wherein the one or more models correspond to the function.

6. The apparatus of claim 1, wherein the controller is a hardware module programmable based on the configuration file; and
wherein the set of neuron memory cells are configured to establish one or more silicon neural networks for executing the pattern matching operation.

7. The apparatus of claim 1, wherein the function is content generation;
wherein the cognitive memory is further configured to:
execute the pattern matching operation based on a piece of data stored in the storage memory; and
analyze the piece of data in the cognitive memory based on the execution of the pattern matching operation; and
wherein the controller is configured to generate a piece of content for the piece of data based on the analysis.

8. The apparatus of claim 1, wherein the function is selective retrieval;
wherein the cognitive memory is further configured to:
execute the pattern matching operation based on a piece of data stored in the storage memory; and
determine whether the piece of data is recognized by the cognitive memory; and
wherein the controller is configured to determine whether to retrieve the piece of data from the storage memory based on the recognition.

9. The apparatus of claim 1, wherein the function is selective recording;
wherein the cognitive memory is further configured to:
execute the pattern matching operation based on a piece of data received by the apparatus; and
determine whether the piece of data is recognized by the cognitive memory; and
wherein the controller is configured to determine whether to store the piece of data in the storage memory based on the recognition.

10. The apparatus of claim 1, further comprising a non-volatile cache memory configured to temporarily store data for operations of the controller.

11. A storage device, comprising:
a storage memory comprising a plurality of non-volatile memory cells;
a cognitive memory comprising a set of neuron memory cells; and
a controller comprising a programmable hardware module;
wherein the storage memory is configured to store data;
wherein the controller is configured to program a function for the storage device based on a configuration file, wherein the function indicates one or more operations for the data stored in the storage memory;
wherein the set of neuron memory cells are configured to:
store a knowledge base for facilitating the function; and
execute a pattern matching operation between the data stored in the storage memory and data in the set of neuron memory cells; and
wherein the controller is further configured to execute the one or more operations within the storage device based on an output of the pattern matching operation from the cognitive memory.

12. The storage device of claim 11, wherein a neuron memory cell in the set of neuron memory cells comprises:
a recall memory configured to store a reference pattern indicated in the knowledge base; and
triggering circuitry configured to determine a distance between an incoming pattern indicated in the pattern matching operation and the reference pattern.

13. The storage device of claim 12, wherein a respective committed neuron memory cell in the set of neuron memory cells receives the incoming pattern in parallel; and
wherein the triggering circuitry is further configured to trigger the neuron memory cell in response to the distance being the closest distance among a set of distances, which are associated with the incoming pattern and calculated by the set of neuron memory cells.

14. The storage device of claim 11, wherein the controller is further configured to:
select the configuration file based on a requirement of an application; and
obtain the configuration file from the storage memory.

15. The storage device of claim 11, wherein the controller is further configured to:
obtain the knowledge base from a set of knowledge files stored in the storage memory; and
load the knowledge files to the set of neuron memory cells to enable one or more models in the knowledge base to operate, wherein the one or more models correspond to the function.

16. The storage device of claim 11, wherein the hardware module is programmable based on the configuration file; and
wherein the set of neuron memory cells are configured to establish one or more silicon neural networks for executing the pattern matching operation.

17. The storage device of claim 11, wherein the function is content generation;
wherein the cognitive memory is further configured to:
execute the pattern matching operation based on a piece of data stored in the storage memory; and
analyze the piece of data in the cognitive memory based on the execution of the pattern matching operation; and
wherein the controller is configured to generate a piece of content for the piece of data based on the analysis.

18. The storage device of claim 11, wherein the function is selective retrieval;
wherein the cognitive memory is further configured to:
execute the pattern matching operation based on a piece of data stored in the storage memory; and
determine whether the piece of data is recognized by the cognitive memory; and
wherein the controller is configured to determine whether to retrieve the piece of data from the storage memory based on the recognition.

19. The storage device of claim 11, wherein the function is selective recording;
wherein the cognitive memory is further configured to:
execute the pattern matching operation based on a piece of data received by the storage device; and
determine whether the piece of data is recognized by the cognitive memory; and
wherein the controller is configured to determine whether to store the piece of data in the storage memory based on the recognition.

20. The storage device of claim 11, further comprising a non-volatile cache memory configured to temporarily store data for operations of the controller.
